(19) United States
(12) Patent Application Publication
(10) Pub. No.: US 2004/0197521 A1
(43) Pub. Date: Oct. 7, 2004

(54) Reversible slip-resistant trunk liner

(76) Inventor: James C. Morriston, Belmont, NC (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/752,459

(22) Filed: Jan. 6, 2004

Related U.S. Application Data
(60) Provisional application No. 60/439,263, filed on Jan. 10, 2003.

(51) Int. Cl. D03D 27/00; B32B 33/00; B32B 25/04; B32B 21/04

(52) U.S. Cl. 428/95; 428/537.1; 428/492; 428/903.3

(57) ABSTRACT

A reversible slip-resistant trunk liner for passenger vehicles is disclosed including a rigid inner core layer having a first surface and a second surface, a fibrous surface layer affixed to the first surface of the rigid inner core layer, a slip-resistant surface layer affixed to the second surface of the rigid inner core layer, and wherein the slip-resistant surface layer has a coefficient of friction sufficient to substantially limit travel of contents in a vehicle trunk positioned thereon.

### CROSS-REFERENCE TO RELATED APPLICATIONS

This application claims the benefit of U.S. Provisional Application Serial No. 60/439,263, filed on Jan. 10, 2003, entitled REVERSIBLE SLIP-RESISTANT TRUNK LINER.

### TECHNICAL FIELD OF THE INVENTION

This invention relates generally to a rear trunk and trunk liner of a passenger vehicle. More specifically, the present invention relates to an automotive vehicle with a rear trunk liner that incorporates a slip-resistant side and a stiffening member sandwiched between the slip-resistant side and a carpeted side.

### BACKGROUND OF THE INVENTION

Most automotive vehicles, especially passenger-type vehicles, have a trunk located in a rear region of the vehicle. The floor of the trunk typically has a sunken well for storage of a spare tire. With the exception of the sunken well, the floor of the trunk is typically covered with a blanket of sound insulation to prevent road noise from passing through the trunk region and into the passenger compartment via the rear seat of the vehicle. A carpet is installed on top of the sound insulation. The carpet usually covers the sunken well cap or door that encloses the spare tire, jack and wheel lug wrench. The tire stored in the sunken well may be a temporary small-size spare tire or a regular full-size spare tire. It is desirable to provide a trunk liner that essentially covers most of the trunk region of the vehicle and incorporates an enclosure door over the sunken well which stores the spare tire. It is desirable to provide a trunk liner that can be quickly assembled onto the trunk floor of an automotive vehicle. It is also desirable to provide an automotive vehicle trunk liner that will maintain its position within the trunk without the extensive use of fastening devices.

Various cargo bed liners used to protect the surface of cargo beds are described in prior art patents. One-piece molded plastic truck liners comprising a front wall, opposing side walls and a bottom wall are shown in U.S. Pat. No. 4,341,412 to Wayne; U.S. Pat. No. 4,336,963 to Nix et al.; U.S. Pat. No. 4,181,349 to Nix et al.; U.S. Pat. No. 4,047,749 to Lambitz; U.S. Pat. No. 3,814,473 to Lorenzen; and U.S. Pat. No. 4,592,583 to Dresen. All of the above patents show plastic liners that fit in the truck cargo bed and bear on the bed floor, walls, and rails at various points of contact, either by design or due to irregular liner shapes and warping after the vacuum-formed manufacturing process. Where the liner meets the cargo bed there may be rubbing because one-piece molded plastic truck liners shift, particularly as the truck is being loaded and unloaded, and as cargo shifts during transport.

There are known truck cargo bed liners having anti-slip upper surface for restraining cargo during transport, loading, and unloading. The anti-slip surfaces comprise a layer having a higher co-efficient of friction than the plastic forming the liner. (See: U.S. Pat. No. 4,693,507, for example.) The non-slip layer may be coextruded with, adhered to, or thermally attached to the plastic base material before or during the liner vacuum forming process. Although non-slip upper surfaces in bedliners are effective for restraining cargo during transport, there is additional rubbing of the under side of the HDPE base material against the truck cargo bed because the cargo's weight shifts the cargo and the liner to which it is now restrained.

These and other one-piece molded plastic truck liners have interior surfaces with a relatively low co-efficient of friction that facilitates the sliding of cargo across the bottom wall during loading and unloading of the cargo. However, for some applications, the relatively low friction surface of the bottom wall is a considerable disadvantage because certain types of cargo will slide around quite freely when the truck is accelerating, decelerating and negotiating turns. Such cargo has a tendency to slide to the front of the liner against the liner front wall, with the result that the truck operator must frequently climb into the truck bed and liner to retrieve and unload cargo objects from the truck.

A need exists for a reversible trunk liner for passenger vehicles, including sport utility vehicles and vans, that incorporates a slip-resistant side and a stiffening member sandwiched between the slip-resistant side and a carpeted side.

### SUMMARY OF THE INVENTION

The present invention eliminates the above-mentioned needs for a reversible slip-resistant trunk liner for passenger vehicles that incorporates a slip-resistant side and a stiffening member sandwiched between the slip-resistant side and a carpeted side.

In accordance with the present invention, there is provided a reversible slip-resistant trunk liner for passenger vehicles including a rigid inner core layer having a first surface and a second surface, a fibrous surface layer affixed to the first surface of the rigid inner core layer, a slip-resistant surface layer affixed to the second surface of the rigid inner core layer, and wherein the slip-resistant surface layer has a coefficient of friction sufficient to substantially limit travel of contents in a vehicle trunk positioned thereon.

The present invention is additionally directed to a reversible slip-resistant trunk liner for passenger vehicles including a rigid layer have a first surface and a second surface, a surface layer affixed to the first surface of the rigid layer, and wherein the rigid layer is sufficiently rigid to support contents in a vehicle trunk positioned thereon.

### BRIEF DESCRIPTION OF THE FIGURES

FIG. 1 is a side view illustration of the preferred embodiment of the present invention.

### DETAILED DESCRIPTION OF THE PREFERRED EMBODIMENT

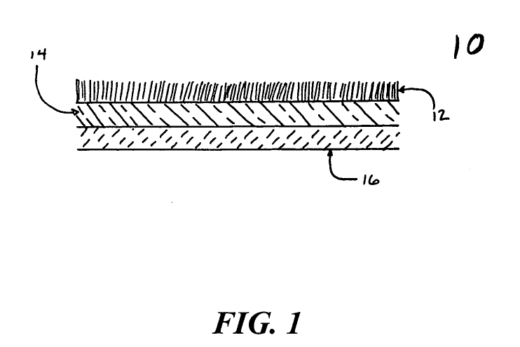

Referring now to FIG. 1, a preferred embodiment of the present invention is illustrated as reversible slip-resistant trunk liner 10. Reversible slip-resistant trunk liner 10 includes fibrous surface layer 12, inner core layer 14, and slip-resistant surface layer 16.

Reversible slip-resistant trunk liner 10 is preferably rigid, so that it can support materials without deforming to the point of allowing such materials to be displaced into the spare tire well in the floor of a trunk. Inner core layer 14 provides rigidity. Inner core layer 14 can be formed of a variety of materials, including but not limited to plastic or polymer laminates, fiberboards, and wood boards. Furthermore, such rigidity facilitates an ease of use in alternating between fibrous surface layer 12 and slip-resistant layer 16.

In an alternative embodiment of the present invention, inner core layer 14 may be absent, provided that either surface layer is sufficiently rigid to support a reasonable weight on the vehicle trunk.

Fibrous surface layer 12 can be formed from carpet material or other lining. This permits the manufacturer to form fibrous surface layer 12 from the same materials as are used elsewhere in the vehicle.

Slip-resistant surface layer 16 can be formed from an array of materials as well. Such materials include, but are not limited to recycled rubber, rubber, polyolefins, polyesters, plastics (such as thermoplastics), and epoxies. It is preferred that slip-resistant surface layer 16 be formed at least partially from a recycled rubber material. It is additionally preferred that slip-resistant surface layer 16 have a coefficient of friction sufficient to prevent significant movement of contents or materials placed thereon and stored in the trunk. Slip-resistant surface layer 16 may obtain its coefficient of friction from a selected surface pattern, such as smooth, rough, grooved, or likewise textured pattern.

Slip-resistant surface layer 16 and fibrous surface layer 12 can be bonded to inner core layer 14 through a variety of methods well known in the art, such as hot-melt bonding, adhesives, RF welding, and the like.

It is preferred that reversible slip-resistant trunk liner 10 have acoustic properties that limit or restrict sound wave penetration. Such acoustic properties benefit the passengers of the vehicle in that less sound, such as road noise, enters the passenger compartment of the vehicle. These beneficial acoustic properties can be accomplished by an array of materials, including but not limited to a thermoplastic material. Such a thermoplastic material may additionally have rubber or rubber-like characteristics.

Other important characteristics of reversible slip-resistant trunk liner 10 include: ease of cleaning, resistance to moisture absorption, resiliency, and toughness. These characteristics impart improved durability and ease of use to reversible slip-resistant trunk liner 10.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. A reversible slip-resistant trunk liner for passenger vehicles, comprising:
a rigid inner core layer have a first surface and a second surface;
a fibrous surface layer affixed to said first surface of said rigid inner core layer;
a slip-resistant surface layer affixed to said second surface of said rigid inner core layer; and
wherein said slip-resistant surface layer has a coefficient of friction sufficient to substantially limit travel of contents in a vehicle trunk positioned thereon.

2. The reversible slip-resistant trunk liner of claim 1 wherein said rigid inner core layer is a polymer laminate.

3. The reversible slip-resistant trunk liner of claim 1 wherein said rigid inner core layer is a plastic laminate.

4. The reversible slip-resistant trunk liner of claim 1 wherein said rigid inner core layer is at least partially formed from wood.

5. The reversible slip-resistant trunk liner of claim 1 wherein said fibrous surface layer is a carpet material.

6. The reversible slip-resistant trunk liner of claim 1 wherein said slip-resistant surface layer is at least partially formed from recycled rubber.

7. The reversible slip-resistant trunk liner of claim 1 wherein said fibrous surface layer is affixed to said first surface by an adhesive.

8. The reversible slip-resistant trunk liner of claim 7 wherein said slip-resistant surface layer is affixed to said second surface by an adhesive.
